(19) United States
(12) Patent Application Publication
(10) Pub. No.: US 2008/0236419 A1
(43) Pub. Date: Oct. 2, 2008

(54) Roller Cassette for Semi-Rotary Machines, Which Can Be Inserted Into Offset Printing Units

(76) Inventor: Jose Betes Peruga, Sant Cugat del Valles (ES)

Correspondence Address: KED & ASSOCIATES, LLP, P.O. Box 221200, Chantilly, VA, 20153-1200, US

(21) Appl. No.: 12/065,183

(22) PCT Filed: Aug. 30, 2005
(86) PCT No.: PCT/ES05/00481

§ 371 Date: Feb. 28, 2008

(51) Int. Cl. B41F 7/02

(52) U.S. Cl. 101/217

(57) ABSTRACT

The invention relates to a roller cassette for semi-rotary machines, which can be inserted into offset printing units. The invention comprises at least three rollers, namely: at least one printing plate roller in the form of a first roller, one transfer roller in the form of a second roller and a printing cylinder or counter-cylinder in the form of a third roller. The invention is characterised in that the printing rollers (3) in the cassette are disposed in a semi-rotary configuration, with the second and third rollers being disposed in the same vertical plane or with a slight inclination in relation to said plane and the first roller being disposed in a tangential plane or inclined in relation to the plane of the second and third rollers. In this way, when the cassette is inserted into a printing unit (2) that is designed to receive roller cassettes, said unit can print with the specific printing characteristics of the semi-rotary rollers (3).

A roller cassette for semi-rotary machines insertable in offset printing units, which includes at least three rollers, at least one for a printing plate in the form of a first roller, one for transfer in the form of a second roller and a counter-cylinder in the form of a third roller, which is characterised in that the mentioned cassette said rollers are arranged in a semi-rotating manner, with the second and third rollers in the same vertical plane or with a slight inclination with respect to said plane and the first in a tangential or inclined plane with respect to the second and third rollers, so that when said cassette is inserted into the printing unit designed for the reception of roller cassettes provides this with the property of carrying out the printing with the characteristics belonging to semi-rotating roller printing.

### BACKGROUND OF THE INVENTION

Rotating and semi-rotating printing machines are known in the state of the art that print on paper or other media by making this pass and circulate through specially-designed rollers.

The specific operation of such machines depends on the constitutive typology of the cited rollers and may be rotating or semi-rotating.

In the case of rotating operation, the rollers present a completely circular transverse section and are symmetrical around their own central longitudinal axis. The paper passes through and circulates between two rollers at the same time and receives the print via the entire circular lateral and perimetral surface of the upper roller, with said rollers continuously rotating over each other and in different rotating directions around their respective axes, between them.

Rotating printing involves a higher printing speed and, hence, better adapted to long, multi-format printing runs, with semi-rotating printing best adapted to short runs.

In semi-rotating operation, the rollers can present a completely circular transverse section or for the said rollers are sectioned longitudinally, presenting a semi-circular transverse section or with a circle section or presenting or double a multiple radius.

This is so because there is a moment in a semi-rotating machine during which the paper moves backwards, which means that, for an instant of time, said paper is not under pressure between the rollers so that it is able to move backwards driven by the drive and inserter motors.

Similarly, a rubber blanket is usually installed in the printing zone that prints onto the paper or media at the same time fixing the paper or media. Generally, the zone where there is no blanket is used so that the paper or media is free and able to move.

This is because, in the semi-rotating machine (as in the continuous rotating machine), the upper and lower printing rollers always rotate in different directions. The difference with respect to the rotating machine is that the in the semi-rotating, there are roller zones that do not make any pressure on the lower roller, zone without blanket or with a different radius. At this moment, when the paper is released, the drive motors at the end of the machine (OUTFEED), together with the inserter motor, which maintains paper tension at the entrance (INFEED), produce the oscillating movement, taking it backwards and allowing the desired zone to be printed.

Such a circumstance involves the paper only being printed by the lateral perimetral surface of the roller that corresponds to the perfectly circular portion of the transverse section of this and which does not have a double or multiple radius and which only passes and receives simultaneous printing of one roller. The paper moves forwards and backwards, synchronised with the part of the smaller radius of the second roller, which releases the paper, as well as the insertion and drive motors.

In the current state of the art, only the rotating types of rollers are fitted and available for operation inside a cassette, which is insertable and extractable from the printing unit without any need for moving or dismantling this.

However, semi-rotating rollers are not available for operation inside cassettes, but instead are directly fitted inside the machine, so that in order to change from the rotating type of printing to semi-rotating, the machine itself has to be replaced, with all the drawbacks that this involves.

### A BRIEF DISCLOSURE OF THE PRESENT INVENTION

The present invention represents a significant advance in the semi-rotating printing machinery sector because it allows the conversion and transformation of the same printing unit belonging to a semi-rotating machine from rotating operation to semi-rotating operation or vice-versa in a simple, quick fashion, without any need whatsoever to move or dismantle the machine.

It is thus possible to have a single semi-rotating machine adaptable to both printing methods in a fully reversible manner, using the rotating or semi-rotating printing methods according to requirements.

This possibility means significant economic savings because it allows a single machine to be available that is compatible with both types of operation and not a machine for each of the types of printing, in addition to the associated space savings.

Another improvement of the following cassette lies in the fact that it can incorporate an arrangement in which the upper cylinder has a double or multiple radius, for example it could be the circular section that does not occupy the blanket and the lower cylinder also has a double or multiple radius, for example a flattening or necking.

The inventor has seen that in semi-rotating machines, at the moment of backwards motion, said machine has to decelerate to a speed of 0 m/s in order to subsequently accelerate in the opposite direction. If both the upper and lower cylinders have double or multiple radii, the space in which the paper is released can be programmed without the pressure of at least one of the cylinders, with said dephase being increased in the case of very small printing by the free-play of the double or multiple radii of the upper and lower cylinders, in this way the paper or media is free from the pressure of one of the cylinders for more time in order to reverse the direction of paper or media advance, which significantly increases the final machine operating speed.

One objective of the present invention is a roller cassette for semi-rotating machines insertable in offset printing units, which includes at least three rollers, at least one printing plate in the form of a first roller, one for transfer in the form of a second roller and a counter-cylinder or printing cylinder in the form of a third roller, which is characterised in that the mentioned cassette said rollers are arranged in a semi-rotating manner, with the second and third rollers in the same vertical plane or with a slight inclination with respect to said plane and the first in a tangential or inclined plane with respect to the second and third rollers, so that when said cassette is inserted into the printing unit designed for the reception of roller cassettes provides this with the property of carrying out the printing with the characteristics belonging to semi-rotating roller printing.

An additional objective of the present invention is a roller cassette for semi-rotating machines, in accordance with the previous paragraph that is characterised in that the second and third rollers have a double or multiple radius and their rotations are synchronised together.

### BRIEF DISCLOSURE OF THE DRAWINGS

In order to facilitate the description, this report is accompanied by three pages of drawings that illustrate a practical exemplary embodiment, which is cited for guideline purposes only and as a non-limiting example of the present invention.

FIG. 1 is view of a printing unit set-up with an inserted cassette.

FIG. 2 is a view of a cassette of the invention, with an arrangement of its interior semi-rotating rollers.

FIG. 3 is a view in greater detail of a cassette of the invention, with the connection to the printing unit in which it is inserted for its operations.

### CONCRETE EMBODIMENT OF THE APPLICATION

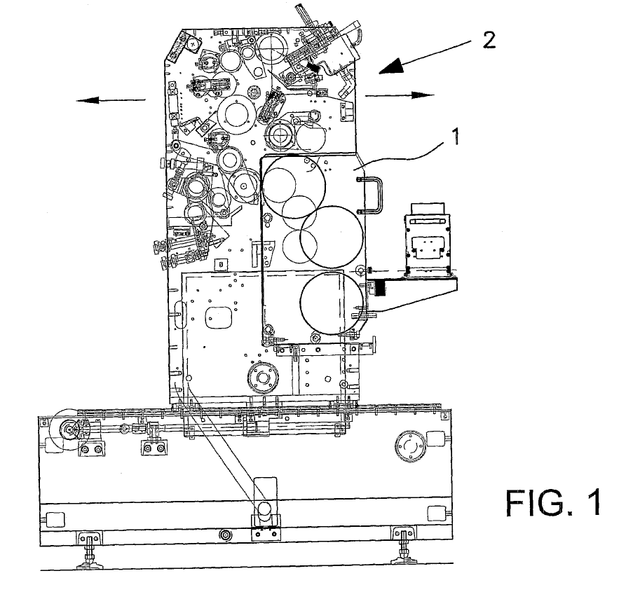

Thus, FIG. 1 illustrates a cassette 1 and a printing unit 2.

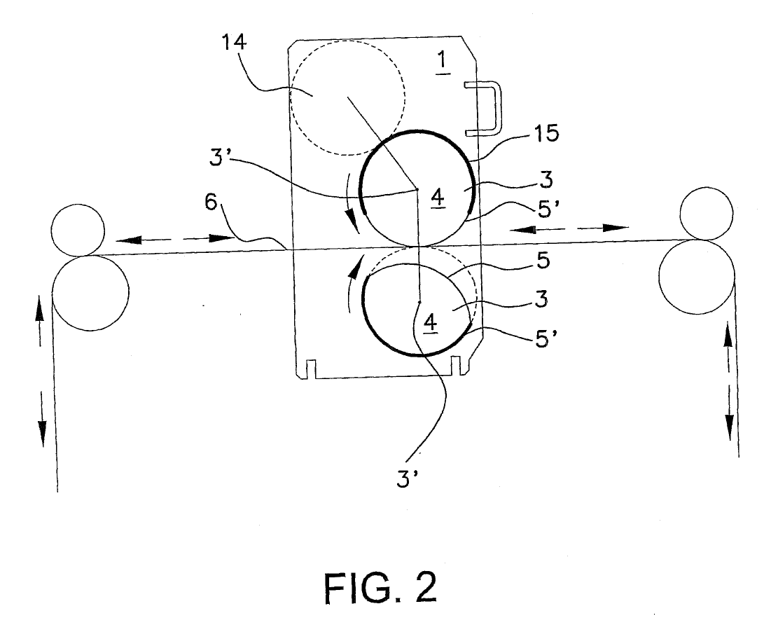

FIG. 2 shows the referred cassette 1, its first roller 14, its second and third rollers 3, their shafts 3′ and its transverse sections 4, surfaces 5 and 5′ perimetral laterals of these, a blanket 15, the paper 6 for printing and the printing unit 2.

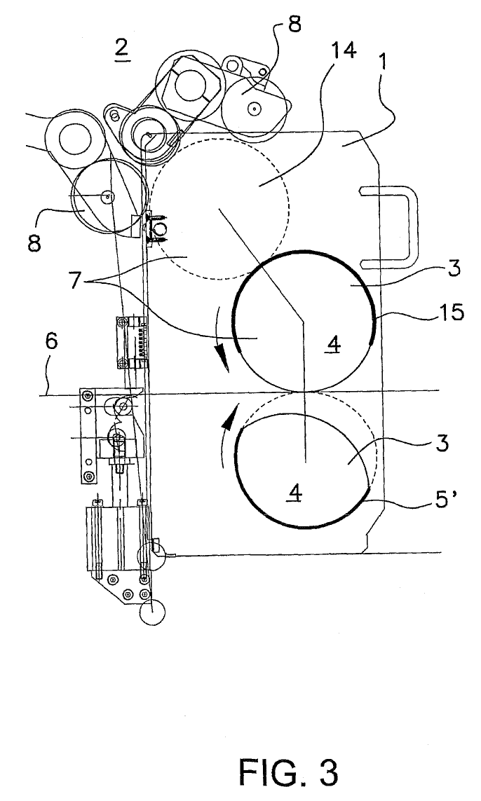

FIG. 3 shows the cassette 1, its first roller 14, its second and third rollers 3, its transverse sections 4, surfaces 5′ perimetral laterals of these, a blanket 15, the paper 6 for printing, the gearing system 7 for synchronisation of roller rotation 3 and the actual printing unit 2 drive system 8 with the rollers 3 of the cassette 1.

In a specific exemplary embodiment and just as can be seen in FIG. 1 of the assembly, cassette 1 of the invention corresponds to the types that are insertable into and extractable from a printing unit 2. The printing unit 2 is adapted for the insertion and extraction of cassette 1 and also for driving and moving its elements when inserted.

However, as shown in FIG. 2, the cassette 1 of the present invention, which is extractable, presents the characteristic of incorporating a printing roller 3 system inside, of the semi-rotating type, with the printing properties of the cassette 1 and in consequence of the printing unit in which it is inserted, are those of semi-rotating printing.

In accordance with the constitutive typology of the semi-rotating type of printing rollers, the transverse section 4 of the second and third rollers 3, inside cassette 1 is not completely circular, but instead presents a constitutive geometry of double or multiple radius, or which is the same, does not maintain contact with the paper or media to be printed over all the perimeter.

This is because, in this exemplary embodiment, the blanket 15 does not completely cover the second cylinder surface, so that where there is no blanket and because of its thickness, if its radius is measured, it will be found to differ from the radius taken in the zone where there is blanket.

Because of this, pressure and printing are only produced on the paper or media along the length of the zone where the blanket 15 exists, taking advantage of the zone without blanket to release the paper or media.

The printing rollers 3 make a rotating movement around their own shaft 3′ (which, in the figures is also perpendicular to their plane and only represented by their intersection point), so that the paper 6 or media partly move backwards to take maximum advantage of the surface of the paper or media to be printed in accordance with the oscillating and cyclic rotational movement made by the inserter and drive motors in one and the other directions. The cited movements are indicated by arrows in FIG. 2.

Another characteristic of the cassette 1 of the invention lies in the fact that the rollers 3 are synchronised in rotation by a gearing system 7 (FIG. 3), so that the two rollers 3, the surfaces 5′ of which directly face each other, allow a certain dephase in the relative angular position between them, consequently not showing a symmetrical position between them on each side of the paper 6 (taking the paper as if it were a plane of symmetry).

Such a circumstance and also due to the existence of a double or multiple radius on both rollers 3, enables the space and the time for the paper 6 to pass and circulate between these to be regulated, which allows the paper to be released during the necessary time and permits the printing speed to be increased with respect to a conventional semi-rotating machine and means that sudden deceleration and acceleration of the paper or media do not have to be forced, since the system for decelerating and accelerating the advance and return movement of the paper or media can be adjusted with greater space.

When the cassette 1 is inserted into the printing unit 2, its gearing system 7 is connected to the printing unit 2 drive system 8 and is therefore driven by the printing unit's 2 own drive system with the first roller 14 and cassette 1 interior rollers 3, together with the gearing system 7 for rotation synchronisation.

The cassette 1 is interchangeable in the printing unit 2 with a similar cassette, except for having rotating print type rollers.

Since the cassette 1 of the present invention is insertable into the printing unit 2, it endows this with semi-rotating printing properties. The ability to being interchangeable with a rotating roller cassette in the same printing unit 2 enables this machine (semi-rotating) to adopt rotating printing properties, with it only being necessary to insert the cassette corresponding to this function, without the need for a different machine for each type of operation.

The present invention patent describes a new roller cassette for semi-rotating machines that is insertable in offset printing units. The examples described here are non-limiting to the present invention and can, therefore, have different applications and/or adaptations, all being within the scope of the following claims.

1. A roller cassette for semi-rotating machines, insertable in offset printing units, which includes at least three rollers, at least one for a printing plate in the form of a first roller, one for transfer in the form of a second roller and a counter-cylinder or printing cylinder in the form of a third roller, characterised in that the mentioned cassette said rollers (3) are arranged in a semi-rotating manner, with the second and third rollers in the same vertical plane or with a slight inclination with respect to said plane and the first in a tangential or inclined plane with respect to the second and third rollers, so that when said cassette is inserted into the printing unit (2) designed for the reception of roller cassettes it provides this with the property of carrying out the printing with the characteristics belonging to semi-rotating roller (3) printing.

2. A roller cassette for semi-rotating machines in accordance with claim 1 characterised in that the second and third rollers (3) have a double or multiple radius and with their rotations synchronised together.
